(19) United States
(12) Patent Application Publication
(10) Pub. No.: US 2016/0113273 A1
(43) Pub. Date: Apr. 28, 2016

(54) PESTICIDE-FREE PHYSICALLY PEST-ISOLATING TRANSPARENT POLYMERIC FILM

(71) Applicant: EU-TOP CORPORATION, NEW TAIPEI CITY (TW)

(72) Inventors: MING-JENG CHEN, NEW TAIPEI CITY (TW); YEN-CHIH CHEN, NEW TAIPEI CITY (TW); PENG-YU CHEN, NEW TAIPEI CITY (TW)

(21) Appl. No.: 14/658,300

(22) Filed: Mar. 16, 2015

Related U.S. Application Data
(63) Continuation-in-part of application No. 14/522,732, filed on Oct. 24, 2014.

(51) Int. Cl. A01N 25/34; A01G 9/14; A01N 27/00

(52) U.S. Cl. CPC A01N 25/34; A01N 27/00; A01G 9/1438; A01G 2009/1446

(57) ABSTRACT

A pesticide-free physically pest-isolating transparent polymeric film is formed of a plastic film that has a thickness of 0.03˜1.00 mm and is perforated to include a plurality of holes. The holes have a hole size of 1˜30 mm and a distribution density of 1,000˜200,000 holes/M² on the plastic film. The pesticide-free physically pest-isolating transparent polymeric film is proven as a simple but very effective way of pest control. It helps plants fully grow without being attacked by pests in a pesticide-free condition. Further, the pesticide-free physically pest-isolating transparent polymeric film is repeatedly usable, and is therefore an easily operable and economical agricultural aid ideal for use.

### CROSS-REFERENCE TO RELATED APPLICATION

This application is a continuation-in-part patent application of U.S. application Ser. No. 14/522,732 filed on Oct. 24, 2014, the entire contents of which are hereby incorporated by reference for which priority is claimed under 35 U.S.C. §120.

### FIELD OF TECHNOLOGY

The present invention relates to a pesticide-free physically pest-isolating transparent polymeric film, and more particularly, to a pesticide-free physically pest-isolating transparent polymeric film that is effective in pest control and helps plants fully grow without the need of using pesticides.

### BACKGROUND

In the current agricultural development, pesticides are frequently used for pest and bird control, so as to produce agricultural crops that have high yield and good appearance. However, the use of pesticides has some disadvantages: (1) the pesticides are also detrimental to the users; (2) the pesticides tend to remain in the plants to endanger the health of people who eat the plants; (3) the spray of pesticides would pollute the living environment and ambient air; and (4) the pesticides also damage the soil. Thus, the growing of organic agricultural crops has become a key point in the modern agricultural development.

In the organic agricultural development, there are still problems in the field of biological control. For example, the use of prepared liquid pepper solution, liquid vinegar solution or other liquid acidic solutions in pest control in the organic agriculture is effective for only very limited types of pests without providing comprehensive and complete ways to prevent plants from being attacked by pests. The black or white shield mesh used for pest control requires higher cost and has the problem of insufficient light permeability that disadvantageously causes reduced crop production. Further, the shield mesh has insufficient mechanical strength and is not repeatedly usable because it tends to break under an externally applied force, such as wind force or tearing by animals.

It has been suggested that big-scale greenhouses with air ventilation should be constructed for pest and bird control. However, the use of big-scale greenhouses requires extremely high construction and maintenance costs, which are generally not affordable by small farmers. Therefore, it is necessary to develop economical and effective means for pest control.

### SUMMARY

A primary object of the present invention is to provide a pesticide-free physically pest-isolating transparent polymeric film that is effective for pest control to reach plant production target and is repeatedly usable, and is therefore an economical means to provide effective pest control without the need of using pesticides.

To achieve the above and other objects, the pesticide-free physically pest-isolating transparent polymeric film according to the present invention is formed of a plastic film that has a thickness of 0.03˜1.00 mm and is perforated to include a plurality of holes; and the holes have a hole size of 1˜30 mm and a distribution density of 1,000˜200,000 holes/M² on the plastic film. It is noted when all the holes have a hole size smaller than 1 mm, the transparent polymeric film would be water-impermeable and have poor breathability to cause the greenhouse effect, preventing plants from growing normally. On the other hand, when all the holes have a hole size larger than 30 mm, the transparent polymeric film would lose its ability in controlling most of the insect pests. Herein, the term “hole size” is defined as the largest linear distance between any two points on one hole.

According to the present invention, the plastic film for forming the pesticide-free physically pest-isolating transparent polymeric film can be a film of polyethylene (PE), polypropylene (PP), ethylene vinyl acetate (EVA), polyester, polyethylene terephthalate (PET) or polyvinyl chloride (PVC).

According to the present invention, the holes formed on the pesticide-free physically pest-isolating transparent polymeric film respectively have a shape selected from the group consisting of a round, a triangular, a square, and a polygonal shape.

According to the present invention, the pesticide-free physically pest-isolating transparent polymeric film can be used as at least one of a bag for fruit pest control, a protective film for plant disease and insect pest control, a shield mesh for bird control, and an isolating film for soil pest control.

The holes on the transparent polymeric film of the present invention can be adjusted in hole size and hole spacing according to the plants to be grown and the pests or animals to be controlled. When the transparent polymeric film is used as a bag for fruit pest control, the hole size can be 1˜2 mm and the hole spacing can be 1˜2 mm; when the transparent polymeric film is used as a protective film for plant disease and insect pest control, the hole size can be 1˜5 mm, the hole spacing can be 2˜5 mm, and the plants to be protected are economically valuable plants, such as fruit trees or vegetables; when the transparent polymeric film is used as a shield mesh for bird control, the hole size can be 30 mm and the hole spacing can be 30 mm; or when the transparent polymeric film is used as an isolating film for soil pest control, the hole size can be 1˜5 mm, the hole spacing can be 7.5 mm, and the hole distribution density can be 24,000 holes/M² on the film.

Another object of the present invention is to provide a method of manufacturing pesticide-free physically pest-isolating transparent polymeric film. To achieve this object, an electric heating roller having a plurality of radially projected teeth is heated for the teeth to thermally perforate a plastic film, so that a plurality of holes is formed on the plastic film. According to another operable embodiment of the present invention, the plastic film can be otherwise pneumatically perforated using an oil-pressure machine, for example.

The pesticide-free physically pest-isolating transparent polymeric film according to the present invention has the following advantages:

1. Pesticide-free growing: The pesticide-free physically pest-isolating transparent polymeric film of the present invention enables effective bio-control, including pest control, bird control and small-size animal control, allowing plants to grow without the need of using pesticides.
2. Good breathability: The holes designed for the pesticide-free physically pest-isolating transparent polymeric film of the present invention are adjustable in hole size, hole amount and hole spacing to effectively isolate various pests and ensure normal growth of the plants without being damaged by the greenhouse effect.
3. Wind-breaking: The pesticide-free physically pest-isolating transparent polymeric film of the present invention is made of a plastic film having a mechanical property strong enough to effectively resist the influence of wind on the plants grown in a natural environment to thereby facilitate plant growth management.
4. Water erosion control: The pesticide-free physically pest-isolating transparent polymeric film of the present invention is perforated with properly designed hole size and hole spacing to provide not only good water permeability, but also good mechanical property for effectively resisting soil erosion by rainwater, so as to protect the plants against abnormal growth.
5. Dust protection: The pesticide-free physically pest-isolating transparent polymeric film of the present invention protects the plants against dust during growth, so that the adult plants are clean with less contamination by dust.
6. Pervious to light: The pesticide-free physically pest-isolating transparent polymeric film of the present invention is made of a highly light-pervious material, i.e., a transparent material, and therefore does not impede the photosynthesis in plants.
7. Light in weight: The pesticide-free physically pest-isolating transparent polymeric film of the present invention is only 50 g/M² in weight, which is favorable to plant growth management.
8. Repeatedly usable: The pesticide-free physically pest-isolating transparent polymeric film of the present invention is formed of a plastic material having a predetermined mechanical strength without the risk of being easily damaged, and therefore can be used repeatedly.
9. Low cost: The pesticide-free physically pest-isolating transparent polymeric film of the present invention is available at a low price of US$1.00/M².

### BRIEF DESCRIPTION

The structure and the technical means adopted by the present invention to achieve the above and other objects can be best understood by referring to the following detailed description of the preferred embodiments and the accompanying drawings, wherein

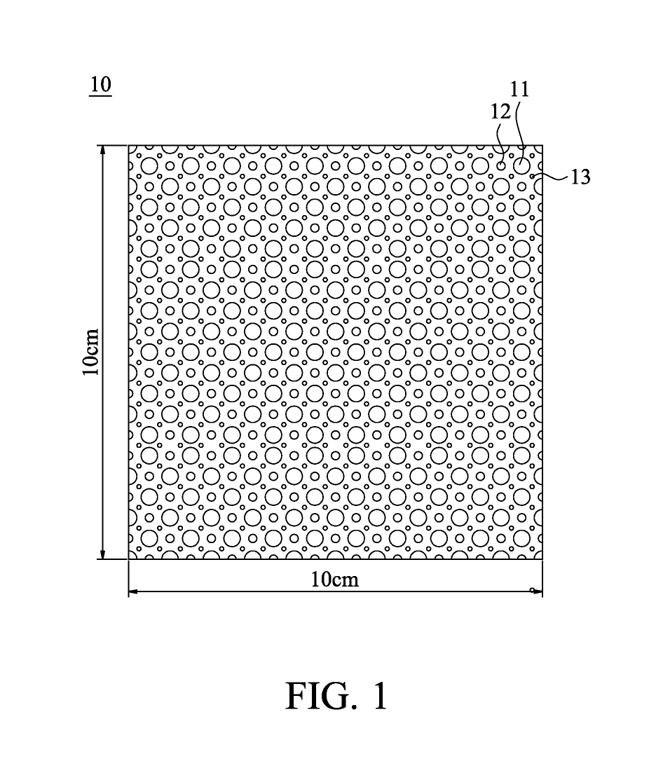

FIG. 1 is a plan view of a pesticide-free physically pest-isolating transparent polymeric film according to a preferred embodiment of the present invention;

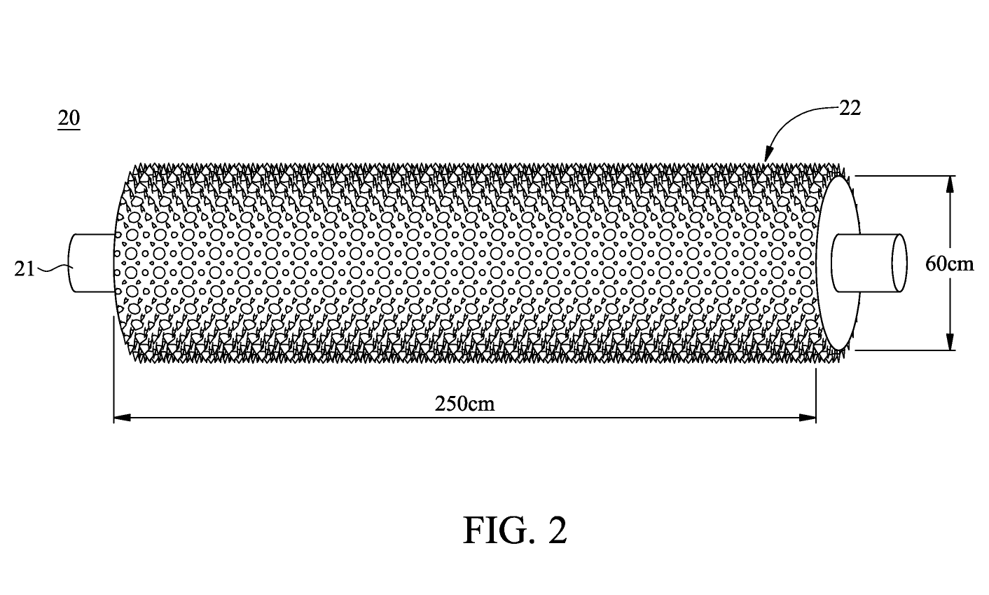

FIG. 2 is a perspective view of an electric heating roller used to produce the pesticide-free physically pest-isolating transparent polymeric film of the present invention;

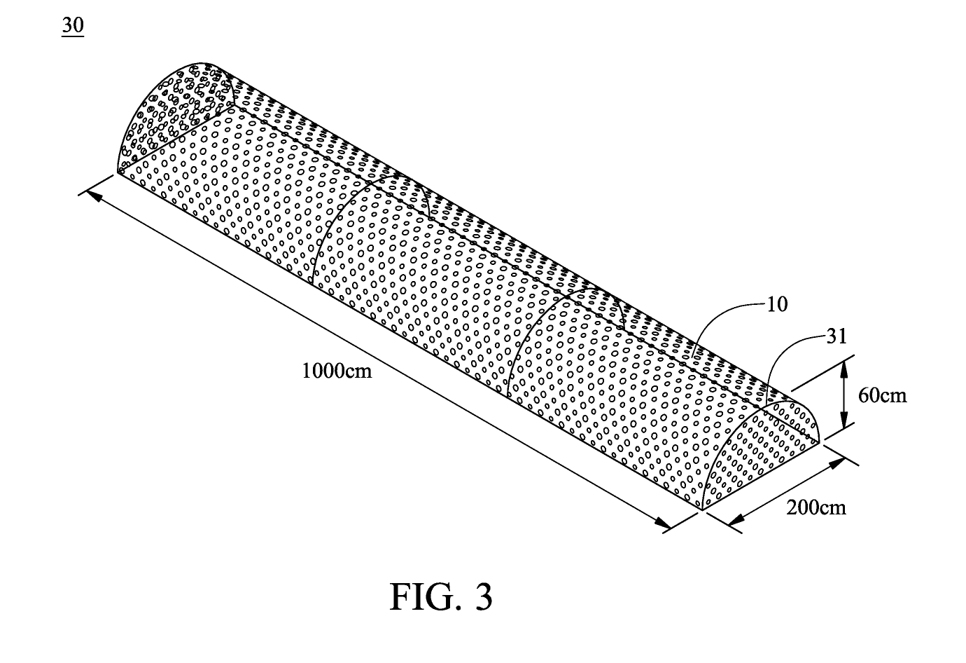

FIG. 3 shows a simple greenhouse constructed using the pesticide-free physically pest-isolating transparent polymeric film of the present invention;

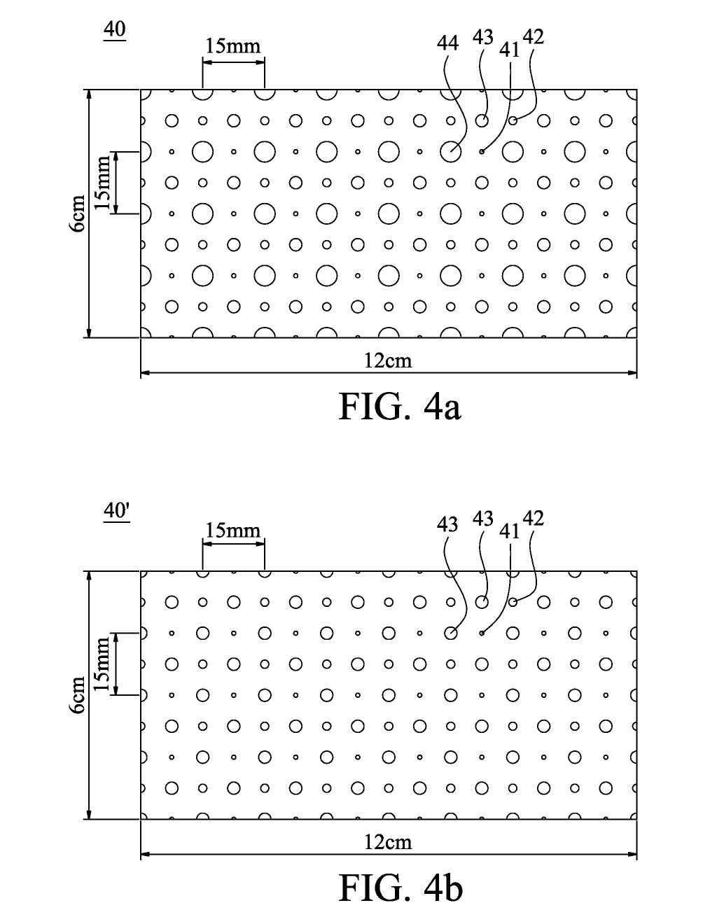

FIGS. 4a and 4b show two different examples of the pesticide-free physically pest-isolating transparent polymeric film of the present invention for use as an isolating film in soil pest control;

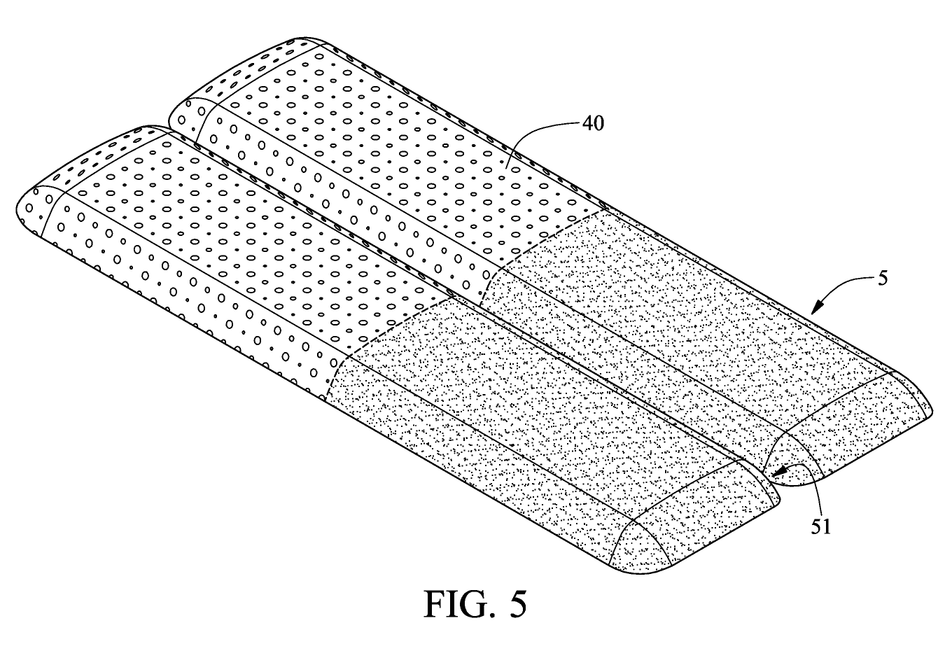

FIG. 5 shows the use of the pesticide-free physically pest-isolating transparent polymeric film of the present invention as an isolating film in soil pest control;

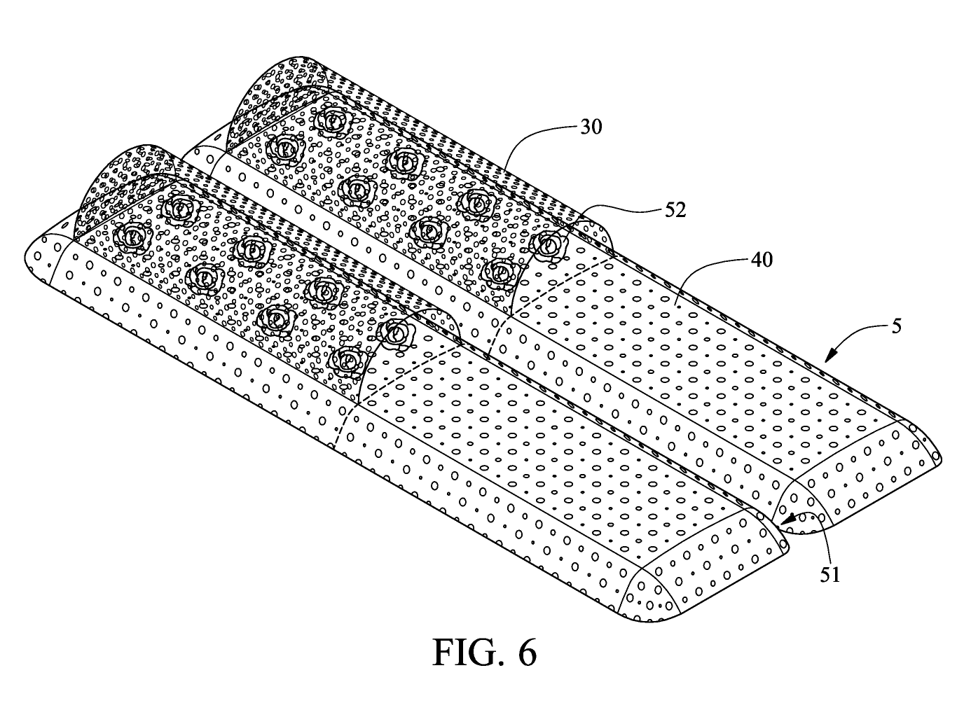

FIG. 6 shows the pesticide-free physically pest-isolating transparent polymeric film of the present invention used as an isolating film in soil pest control can be used with the simple greenhouse of FIG. 3;

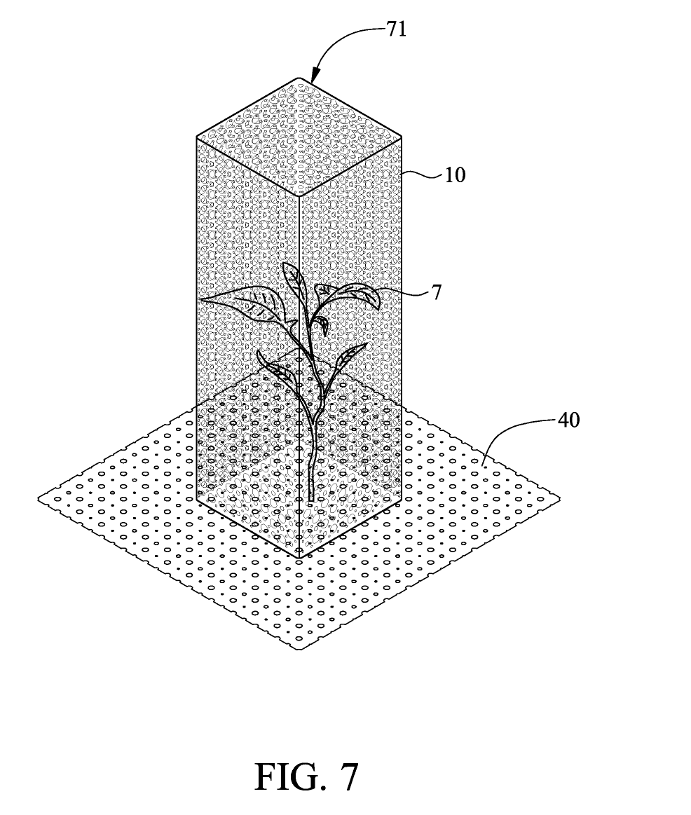

FIG. 7 shows the use of both an isolating film and a protective film made of the pesticide-free physically pest-isolating transparent polymeric film of the present invention to protect one single plant sapling; and

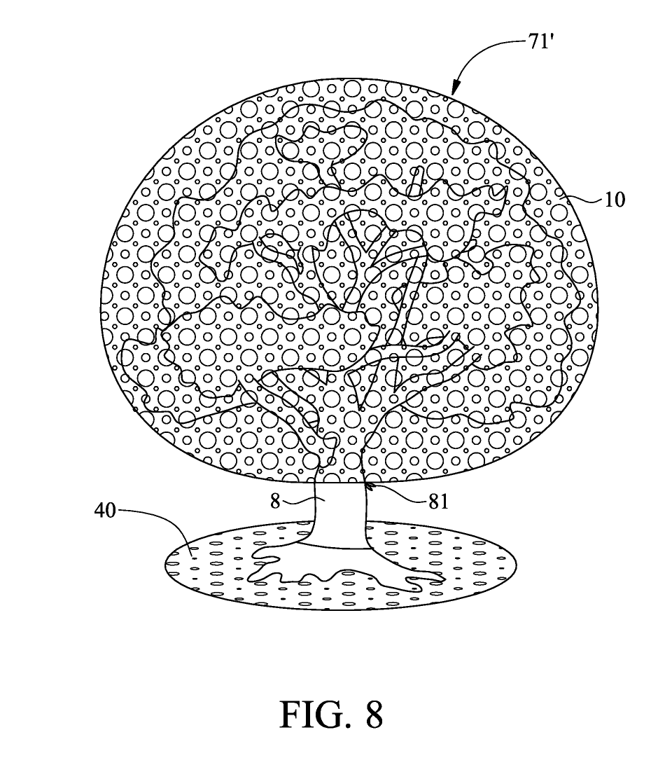

FIG. 8 shows the use of both an isolating film and a protective film made of the pesticide-free physically pest-isolating transparent polymeric film of the present invention to protect one single fruit tree.

### DETAILED DESCRIPTION

The present invention will now be described with a preferred embodiment thereof and by referring to the accompanying drawings.

Please refer to FIG. 1, which is a plan view of a pesticide-free physically pest-isolating transparent polymeric film 10 according to a preferred embodiment of the present invention. For the purpose of conciseness and clarity, the present invention is also briefly referred to as the transparent polymeric film 10 herein. The transparent polymeric film 10 is preferably made of a polyethylene (PE) material and has a thickness of 0.1 mm. The transparent polymeric film 10 is perforated to include a plurality of first holes 11, a plurality of second holes 12 and a plurality of third holes 13. The first holes 11 have a hole size of 4 mm in diameter, a distribution density of 40,000 holes/M², and a hole spacing ranged from 5 to 10 mm. The second holes 12 have a hole size of 2 mm in diameter, a distribution density of 40,000 holes/M², and a hole spacing ranged from 5 to 10 mm. The third holes 13 have a hole size of 1 mm in diameter, a distribution density of 20,000 holes/M², and a hole spacing of 5 mm. That is, the holes 11, 12, 13 formed on the transparent polymeric film 10 have an overall hole distribution density of 100,000 holes/M².

More specifically, the pesticide-free physically pest-isolating transparent polymeric film 10 can be made of a material selected from the group consisting of polyethylene (PE), polypropylene (PP), ethylene vinyl acetate (EVA), polyester, polyethylene terephthalate (PET), and polyvinyl chloride (PVC).

Further, the holes 11, 12, 13 formed on the pesticide-free physically pest-isolating transparent polymeric film 10 can respectively have a shape selected from the group consisting of a round, a triangular, a square, and a polygonal shape. When a particular shape is selected for the holes, an electric heating roller provided with teeth of the selected shape can be used to perforate the transparent polymeric film 10.

Please refer to FIG. 2 that shows an electric heating roller 20 used to produce the transparent polymeric film 10. The electric heating roller 20 is temperature adjustable, and is provided on a circumferential surface thereof with a plurality of radially outward projected teeth 22. The teeth 22 have three different diameters, namely, 1 mm, 2 mm and 4 mm, and a distribution density of 100,000 teeth per square meter (M²). Since the transparent polymeric film 10 is made of the thermoplastic PE material, it can be thermally perforated by the electrically heated teeth 22 on the electric heating roller 20 to form the first, second and third holes 11, 12, and 13 thereon. The electric heating roller 20 includes an electric heater 21 provided on a center shaft thereof. Heat is transferred from the electric heater 21 located on the center shaft of the electric heating roller 20 to the teeth 22 located on the circumferential surface of the electric heating roller 20, and the heated teeth 22 thermally perforate the PE material to obtain the transparent polymeric film 10 having a plurality of differently sized first, second and third holes 11, 12, 13.

Please refer to FIG. 3. The transparent polymeric film 10 can be used to construct a simple greenhouse 30. More specifically, the simple greenhouse 30 has a framework 31 made of a metal material, such as iron, aluminum, zinc or any alloy thereof. Alternatively, the framework 31 can be made of a wooden material, such as bamboo. The pesticide-free physically pest-isolating transparent polymeric film 10 is spread over an outer side of the framework 31 to complete the simple greenhouse 30, in which plants can be grown.

### Experiment 1

The greenhouse 30 shown in FIG. 3 is used to conduct an experimental field plant growth test. The transparent polymeric film 10 used to cover the greenhouse 30 is made of a PE material having a thickness of 0.1 mm and is perforated to form a plurality of holes having different diameters, including 4, 2 and 1 mm. The 4 mm holes have a distribution density of 40,000 holes/M² and a hole spacing of 5 mm; the 2 mm holes have a distribution density of 40,000 holes/M² and a hole spacing of 5 mm; and the 1 mm holes have a distribution density of 20,000 holes/M² and a hole spacing of 5 mm. The plants selected for growing are Chinese little white greens (Chinensis). The Chinese little white greens are grown in the manner of common field plant growth, so that about 30 to 40 days are needed from seeding to cropping. The plants are divided into a control group, in which the plants are not given any biological control via pesticide and greenhouse, and an experimental group, in which the plants are given biological control via the simple greenhouse 30 but not any pesticide.

The experiment results indicate that all the Chinese little white greens grown in the control group, which are not protected with pesticide and the simple greenhouse 30, are eaten by cabbage worms during the period from seedling to adult plant and the yield thereof is zero gram (0 g); and the Chinese little white greens grown in the experimental group, which are not protected with pesticide but grown in the simple greenhouse 30 and accordingly isolated from cabbage worms, have an average weight of 92 g/plant after 34-day growth and an average height of 27 cm. Generally, the Chinese little white greens grown with pesticides and sold in the market have an average weight of 82 g/plant. Therefore, the yield of the Chinese little white greens grown in the simple greenhouse 30 constructed using the transparent polymeric film 10 of the present invention is higher than that of the Chinese little white greens grown with pesticides.

According to analysis, the possible cause for the Chinese little white greens grown in the simple greenhouse 30 to have a higher production than the Chinese little white greens grown with pesticides is that the simple greenhouse 30 using the bio-control transparent polymeric film 10 not only isolates the Chinese little white greens grown therein from pest, but also provides a half-sealed space through the holes 11, 12, 13. As a result, the simple greenhouse 30 internally has not only an average humidity about 5% higher than that of a growing environment exposed to the open air, but also an average temperature about 0.5˜2° C. higher than ambient temperature. The increased relative humidity (>5%) and the increased temperature (>0.5˜2° C.) in the simple greenhouse 30 are growth conditions tolerable by and even more advantageous to the Chinese little white greens. Therefore, the yield of the Chinese little white greens grown in the experimental group is 12% higher than that of the Chinese little white greens grown with pesticides (92-82/82*%).

Meanwhile, the Chinese little white greens grown in the experimental group are subjected to a quantitative analysis of pesticide. The quantitative analysis of pesticide is conducted by making reference to AOAC (Association of Official Agricultural Chemists) official method 2007.01 and the Method of Testing Pesticide Residual in Food—Method of Analyzing Multiple Residuals (5) as published by the Ministry of Health and Welfare, ROC on Dec. 23, 2013, and by using a liquid chromatograph/tandem mass spectrometer (LC/MS/MS) and a gas chromatograph/tandem mass spectrometer (GC/MS/MS). The test results indicate none of the 398 pesticides being examined, including 2,4-Dichlorophenoxyacetic acid (2,4-D), 2,4,5-Trichlorophenoxyacetic acid (2,4,5-T), 3-keto Carbofuran and 3-OH Carbofuran, is found in the Chinese little white greens grown in the experimental group of the experiment conducted for the present invention. It means the Chinese little white greens grown in the experimental group and sent for pesticide residual test are not found with any pesticide residual. The test results prove the use of the pesticide-free physically pest-isolating transparent polymeric film 10 of the present invention is an effective means that ensures plants can be grown without using pesticides and are not contaminated by pesticides sprayed in other neighboring fields.

### Experiment 2

In the Experiment 2, the simple greenhouse 30 shown in FIG. 3 is again used to conduct an experimental field plant growth test, and an isolating film made of the transparent polymeric film of the present invention for soil pest control is further used to cover the soil in the simple greenhouse 30. The isolating film is also made of a polyethylene (PE) material and has a thickness of 0.1 mm. The isolating film is perforated to form a plurality of holes of different diameters, including 1, 2, 3 and 5 mm, and having a hole spacing of 7.5 mm and a hole distribution density of 24,000 holes/M². FIGS. 4a and 4b show two examples of the isolating film 40, 40′. The isolating film 40 shown in FIG. 4a includes first holes 41 having a hole size of 1 mm, second holes 42 having a hole size of 2 mm, third holes 43 having a hole size of 3 mm, and fourth holes 44 having a hole size of 5 mm. The isolating film 40′ shown in FIG. 4b includes first holes 41 having a hole size of 1 mm, second holes 42 having a hole size of 2 mm, and third holes 43 having a hole size of 3 mm.

Please refer to FIG. 5, which shows the use of the isolating film 40 in soil pest control. First, the land for field plant growth is divided into several vegetable plots 5, which respectively have a shape suitable for plant growth. Any two adjacent vegetable plots 5 are separated from each other by a furrow 51 to facilitate irrigation and drainage. The vegetable plots 5 are respectively covered by the isolating film 40 to prevent soil pests from getting in the vegetable plots 5. In FIG. 5, it is shown one half of each vegetable plot 5 is covered by the isolating film 40. The isolating film 40 can be used along with the simple greenhouse 30, as shown in FIG. 6. That is, after the prepared vegetable plots 5 are covered with the isolating film 40 and furrows 51 for irrigation and drainage are provided between any two adjacent vegetable plots 5, target crops 52 are grown on the vegetable plots 5 covered by the isolating film 40. Simple greenhouses 30 can be then set up above the vegetable plots 5, so that the isolating film 40 and the simple greenhouses 30 together provide even better means for plant disease and insect pest control.

The plants selected for growing under the protection of the isolating film 40 and the simple greenhouse 30 are still Chinese little white greens (Chinensis). The Chinese little white greens are grown in the manner of common field plant growth, so that about 30 to 40 days are needed from seeding to cropping. When the isolating film 40 for soil pest control is used with the simple greenhouse 30, an even improved pest control effect can be observed from the full-grown Chinese little white greens. The reason for such improved pest control effect is the use of the isolating film 40 in soil pest control can effectively decrease the insect pests from soil and the use of the isolating film 40 along with the simple greenhouse 30 can therefore be more effective in pest control, compared to the use of only the simple greenhouse 30 constructed with the pesticide-free physically pest-isolating transparent polymeric film 10 of the present invention.

From the above experimental results, the transparent polymeric film 10 of the present invention is proven as a simple but very effective way of pest control. It helps plants fully grow without being attacked by pests in a pesticide-free condition. Further, the transparent polymeric film 10 of the present invention is repeatedly usable, and is therefore an easily operable and economical agricultural aid ideal for use.

FIGS. 7 and 8 show further examples of using the isolating film 40 along with a protective film made of the pesticide-free physically pest-isolating transparent polymeric film 10 of the present invention to protect a plant. In FIG. 7, the land for growing a plant sapling 7 is covered by a sheet of isolating film 40 for soil pest control, and a protective shield 71 easily constructed using the pesticide-free physically pest-isolating transparent polymeric film 10 of the present invention is externally provided around the plant sapling 7 for pest control. Similarly, in FIG. 8, the land for growing a large-size fruit tree 8 is covered by a sheet of isolating film 40 for soil pest control while the fruit tree 8 is directly enclosed in a protective shield 71′, which is formed by the pesticide-free physically pest-isolating transparent polymeric film 10 of the present invention and fixed to the fruit tree 8 via a tie 81 for the purpose of pest control.

Further, it is noted the holes formed on the transparent polymeric film 10 of the present invention can be adjusted in hole size and hole spacing according to the plants to be grown and the pests or animals to be controlled. Meanwhile, the transparent polymeric film 10 can be used in different manners, and the transparent polymeric film 10 present in different manners can be used in combination according to actual need in pest control. For example, when the transparent polymeric film 10 is used to make bags for protecting the plants against fruit pests, the hole size can be ranged between 1 and 2 mm while the hole spacing can be ranged between 1 and 2 mm; when the transparent polymeric film 10 is used as a protective film to protect vegetable greens against plant diseases and insect pests, the hole size can be ranged between 1 and 5 mm while the hole spacing can be ranged between 2 and 5 mm; when the transparent polymeric film 10 is used as a shield mesh for bird control, the hole size can be 30 mm and the hole spacing can be 30 mm; or when the transparent polymeric film 10 is used as an isolating film for soil pest control, the hole size can be ranged between 1 and 5 mm while the hole spacing can be 7.5 mm and the hole distribution density can be 24,000 holes/M² on the film. It is understood, however, the above examples are only illustrative and not intended to limit the scope of the present invention in any way.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A pesticide-free physically pest-isolating transparent polymeric film, comprising a plastic film having a thickness ranged between 0.03 and 1.00 mm, being characterized in that the plastic film is perforated to include a plurality of holes, and that the holes have a hole size ranged between 1 and 30 mm and a hole distribution density of 1,000˜200,000 holes/M² on the plastic film.

2. The pesticide-free physically pest-isolating transparent polymeric film as claimed in claim 1, wherein the plastic film is made of a material selected from the group consisting of polyethylene (PE), polypropylene (PP), ethylene vinyl acetate (EVA), polyester, polyethylene terephthalate (PET), and polyvinyl chloride (PVC).

3. The pesticide-free physically pest-isolating transparent polymeric film as claimed in claim 1, wherein the holes respectively have a shape selected from the group consisting of a round, a triangular, a square, and a polygonal shape.

4. The pesticide-free physically pest-isolating transparent polymeric film as claimed in claim 1, wherein the transparent polymeric film can be used as at least one of a bag for fruit pest control, a protective film for plant disease and insect pest control, a shield mesh for bird control, and an isolating film for soil pest control.

5. The pesticide-free physically pest-isolating transparent polymeric film as claimed in claim 2, wherein the transparent polymeric film can be used as at least one of a bag for fruit pest control, a protective film for plant disease and insect pest control, a shield mesh for bird control, and an isolating film for soil pest control.

6. The pesticide-free physically pest-isolating transparent polymeric film as claimed in claim 3, wherein the transparent polymeric film can be used as at least one of a bag for fruit pest control, a protective film for plant disease and insect pest control, a shield mesh for bird control, and an isolating film for soil pest control.

7. The pesticide-free physically pest-isolating transparent polymeric film as claimed in claim 4, wherein the holes on the transparent polymeric film used as a bag for fruit pest control have a hole size ranged between 1 and 2 mm as well as a hole spacing ranged between 1 and 2 MM.

8. The pesticide-free physically pest-isolating transparent polymeric film as claimed in claim 5, wherein the holes on the transparent polymeric film used as a bag for fruit pest control have a hole size ranged between 1 and 2 mm as well as a hole spacing ranged between 1 and 2 MM.

9. The pesticide-free physically pest-isolating transparent polymeric film as claimed in claim 6, wherein the holes on the transparent polymeric film used as a bag for fruit pest control have a hole size ranged between 1 and 2 mm as well as a hole spacing ranged between 1 and 2 MM.

10. The pesticide-free physically pest-isolating transparent polymeric film as claimed in claim 4, wherein the holes on the transparent polymeric film used as a protective film for plant disease and insect pest control have a hole size ranged between 1 and 5 mm as well as a hole spacing ranged between 2 and 5 mm.

11. The pesticide-free physically pest-isolating transparent polymeric film as claimed in claim 5, wherein the holes on the transparent polymeric film used as a protective film for plant disease and insect pest control have a hole size ranged between 1 and 5 mm as well as a hole spacing ranged between 2 and 5 mm.

12. The pesticide-free physically pest-isolating transparent polymeric film as claimed in claim 6, wherein the holes on the transparent polymeric film used as a protective film for plant disease and insect pest control have a hole size ranged between 1 and 5 mm as well as a hole spacing ranged between 2 and 5 mm.

13. The pesticide-free physically pest-isolating transparent polymeric film as claimed in claim 4, wherein the holes on the transparent polymeric film used as a shield mesh for bird control have a hole size of 30 mm as well as a hole spacing of 30 mm.

14. The pesticide-free physically pest-isolating transparent polymeric film as claimed in claim 5, wherein the holes on the transparent polymeric film used as a shield mesh for bird control have a hole size of 30 mm as well as a hole spacing of 30 mm.

15. The pesticide-free physically pest-isolating transparent polymeric film as claimed in claim 6, wherein the holes on the transparent polymeric film used as a shield mesh for bird control have a hole size of 30 mm as well as a hole spacing of 30 mm.

16. The pesticide-free physically pest-isolating transparent polymeric film as claimed in claim 4, wherein the holes on the transparent polymeric film used as an isolating film for soil pest control have a hole size ranged between 1 and 5 mm, a hole spacing of 7.5 mm, and a hole distribution density of 24,000 holes/M².

17. The pesticide-free physically pest-isolating transparent polymeric film as claimed in claim 5, wherein the holes on the transparent polymeric film used as an isolating film for soil pest control have a hole size ranged between 1 and 5 mm, a hole spacing of 7.5 mm, and a hole distribution density of 24,000 holes/M².

18. The pesticide-free physically pest-isolating transparent polymeric film as claimed in claim 6, wherein the holes on the transparent polymeric film used as an isolating film for soil pest control have a hole size ranged between 1 and 5 mm, a hole spacing of 7.5 mm, and a hole distribution density of 24,000 holes/M².
